(19) United States
(12) Patent Application Publication
(10) Pub. No.: US 2018/0223967 A1
(43) Pub. Date: Aug. 9, 2018

(54) TWO PIECE PISTON WITH VENTING

(71) Applicant: BorgWarner Inc., Aubum Hills, MI (US)

(72) Inventors: Giuseppe BADDARIA, Montevecchia (IT); SeongDo HONG, Ithaca, NY (US); Ganggang YAO, Shanghai (CN)

(21) Appl. No.: 15/748,220

(22) PCT Filed: Jul. 28, 2015
(86) PCT No.: PCT/US2015/042455

§ 371 Date: Jan. 29, 2018

(51) Int. Cl. F16H 7/08

(52) U.S. Cl. CPC F16H 7/0848; F16H 2007/0806; F16H 2007/0891; F16H 2007/0855; F16H 2007/0859; F16H 2007/0812

(57) ABSTRACT

A piston assembly for a tensioner which has a hollow piston body having a first end and a second end; and a cap. At least a portion of the cap fits into the first end of the piston body. The cap has a head and may also have a stem connected to an underside of the head. The cap may also have at least one slit for venting fluid, having 5 a width and a depth. The slit may extend from an outer circumference of the stem and across the underside of the head. The slits may be parallel to a centerline of the cap or angled relative to the centerline of the cap. A plurality of slits may be present on the cap. At least two of the plurality of slits may have different widths or different depths. The slits may be evenly 10 spaced around the cap.

### BACKGROUND OF THE INVENTION

### Field of the Invention

The invention pertains to the field of tensioners. More particularly, the invention pertains to a two piece piston assembly with venting.

### Description of Related Art

In conventional tensioners, a single piece piston has a hollow body defining a pressure chamber within the body, the inner end of the body being open to receive a spring and fluid pressure, and the outer end of the body forming a head for pushing on a chain or belt. For venting of the chamber, the single piece piston may contain an aperture which extends from the chamber to the top of the head of the piston, allowing the chamber to vent to atmosphere. Additionally, a check valve or a vent disc may be present in the chamber between the chamber and the aperture leading to atmosphere.

The pistons of hydraulic tensioners are mostly screw machined from steel bars or in some cases cold formed.

### SUMMARY OF THE INVENTION

A piston assembly for a tensioner which has a hollow piston body having a first end and a second end; and a cap. The cap has a head; a stem connected to an underside of the head and fitting within the first end of the piston body; and at least one slit for venting fluid, having a width and a depth, extending from an outer circumference of the stem and across the underside of the head.

The slits may be parallel to a centerline of the cap or angled relative to the centerline of the cap. A plurality of slits may be present on the cap. At least two of the plurality of slits may have different widths or different depths. The slits may be evenly spaced around the cap.

The cap and the piston body may be made of different materials.

In an alternate embodiment, cap has a head; a stem connected to an underside of the head and fits within the first end of the piston body.

In yet another embodiment, the cap has a head with a slit along the outer circumference. The head of the cap is press fit into a hollow piston body.

### BRIEF DESCRIPTION OF THE DRAWING

FIG. 1 shows a sectional view of a hydraulic tensioner.

FIG. 2 shows a side view of a piston body of a first embodiment.

FIG. 3 shows a top view of the piston body of the first embodiment.

FIG. 4 shows a perspective view of the piston body of the first embodiment.

FIG. 5 shows a side view of a piston cap of the first embodiment.

FIG. 6 shows a sectional view of the piston cap of FIG. 5.

FIG. 7 shows a bottom view of the piston cap of FIG. 5.

FIG. 8 shows a perspective view of the piston cap of FIG. 5.

FIG. 9 shows a side view of a piston assembly including a piston body and a cap of the first and second embodiments.

FIG. 10 shows a top view of the piston assembly of the first and second embodiments.

FIG. 11 shows a perspective view of the piston assembly of the first and second embodiments.

FIG. 12 shows a side view of the piston cap of the second embodiment.

FIG. 13 shows an alternate side view of the piston cap of the second embodiment.

FIG. 14 shows a bottom view of the piston cap of the second embodiment.

FIG. 15 shows a perspective view of the piston cap of the second embodiment.

FIG. 16 shows a sectional view of a piston body and a piston cap with vent slits of another embodiment.

FIG. 17 shows a sectional view of an alternate piston body and a piston cap with vent slits.

FIG. 18 shows a sectional view of a hydraulic tensioner of a fourth embodiment.

FIG. 19 shows a sectional view of a hydraulic tensioner of a fifth embodiment.

FIG. 20 shows a side view of a piston cap of another embodiment.

FIG. 21 shows a sectional view of the piston cap of FIG. 20.

FIG. 22 shows a bottom view of the piston cap of FIG. 20.

FIG. 23 shows a perspective view of the piston cap of FIG. 20.

FIG. 24 shows a sectional view of a piston body and a piston cap without vent slits of another embodiment.

FIG. 25 shows a sectional view of an alternate piston body and piston cap without vent slits of another embodiment.

### DETAILED DESCRIPTION OF THE INVENTION

References numbers for items that are common to all the embodiments are used throughout the application.

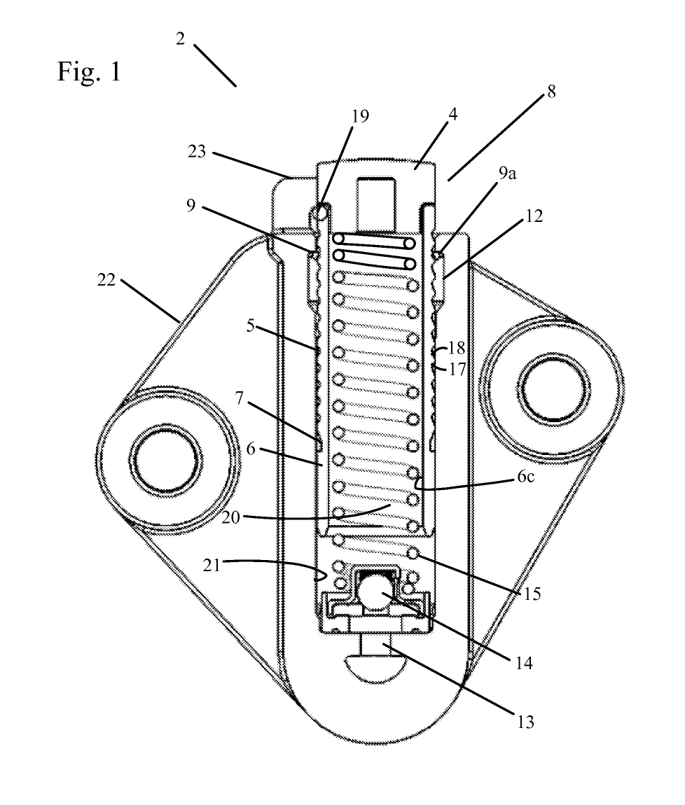

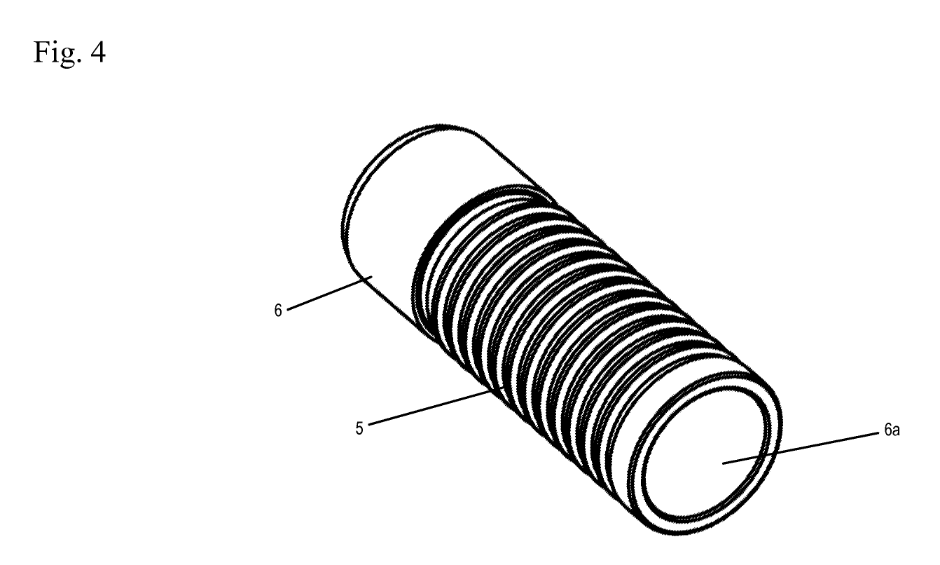

FIGS. 1-8 show a tensioner and a piston assembly of a first embodiment.

Referring to FIG. 1, the tensioner 2 has a housing 22 with a housing bore 21 for slidably receiving a piston assembly 8. The piston assembly 8 includes a hollow piston body 6 and a piston cap 4.

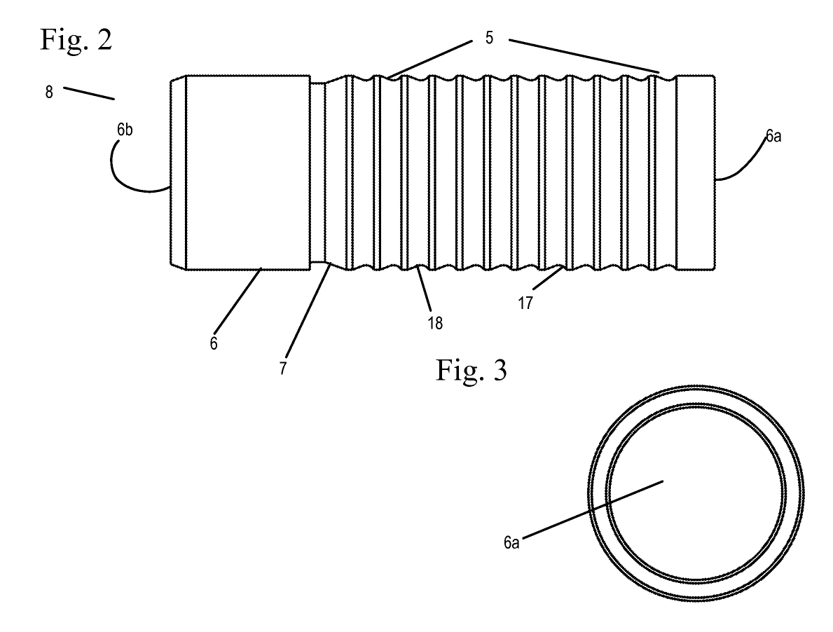

As shown in FIGS. 2-4, the hollow piston body 6 has a first end 6a and a second end 6b. The first end 6a receives the piston cap 4 and the second end 6b is placed within the housing bore 21. The piston cap 4 is preferably press fit into the first end 6a of the piston body 6, although other methods of securing the piston cap 4 to the piston body 6 may also be used.

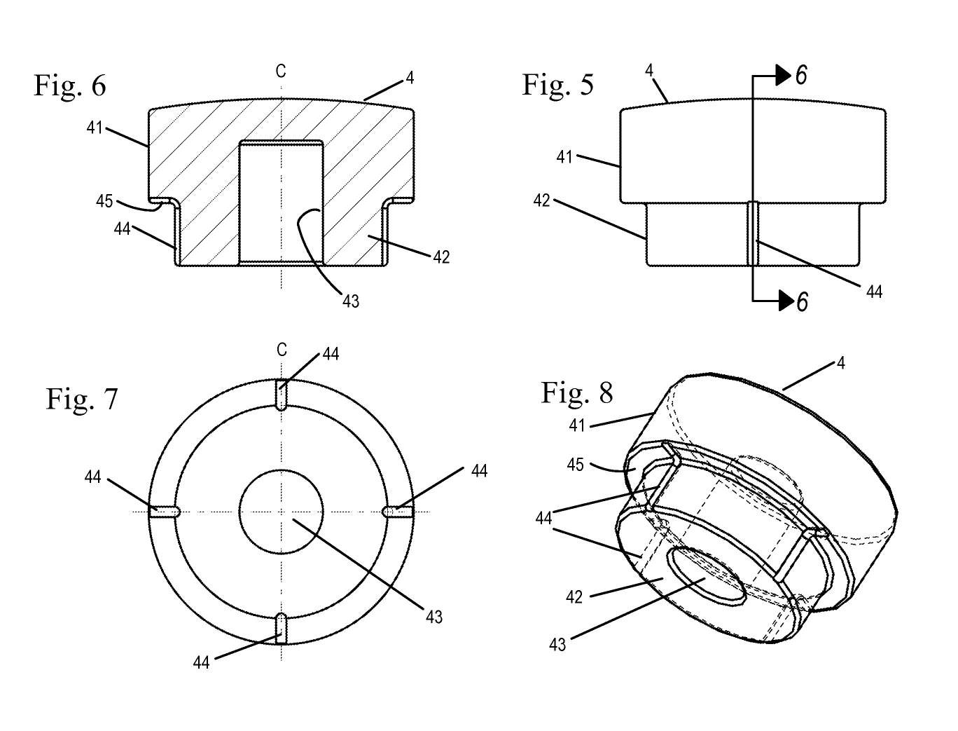

Referring to FIGS. 5-8, the piston cap 4 is mushroom shaped with a head 41 and a stem 42. The stem 42 of the piston cap 4 is received by the first end 6a of the piston body 6, with the underside 45 of the head 41 meeting the first end 6a of the piston body 6. A bore 43, extending from the stem 42 into the top of the head 41 may be present to reduce the weight of the cap. The bore 43 may be other shapes or sizes not shown in the drawings to reduce the weight of the cap 4.

Along the outer surface of at least the stem 42 of the piston cap 4 are slits 44 for oil venting. The vent slits 44 extend from a bottom of the stem 42 to the underside 45 of the head 41 of the cap 4. Fluid can escape or vent from the tensioner, by traveling from the inside of the piston body 6 through the slits 44 on the stem 42 to where the cap 4 meets the piston body 6 and the slits 44 end.

The vent slits 44 are preferably parallel to a centerline C of the cap 4. The slits 44 may be arranged in a pattern around the outer circumference of the stem 42. The slits 44 may be of varying depths and widths. The slits 44 may be spiraled grooves or other shapes. The depth and the number of slits 44 may be determined based on the amount of venting required. The venting of the tensioner 2 controls the hydraulic stiffness of the tensioner. The greater the amount of venting of the tensioner 2, the smaller or decreased amount of hydraulic stiffness of the tensioner 2 and the smaller the amount of venting of the tensioner, the greater or increased amount of hydraulic stiffness of the tensioner. The amount of venting necessary may be determined by calculating the total flow as shown in equation (1.1).

Total flow=A*V (1.1)

Where:

A=Total cross-sectional area of all of the slits in the piston cap, which may be calculated by determining the depth and the width of each of the slits

V=velocity, which is determined by the fluid pressure, type and viscosity of the fluid used in the tensioner system

The slits 44 in the cap 4 provide venting of the piston assembly 8, minimizing or eliminating the need for a vent disk to be present within the piston 6.

It should be noted that the piston cap 4 and the piston body 6 may be made of different materials and manufactured using different technologies. The piston body 6 may for example be a metal tube and the piston cap 4 may be manufactured using different materials and methods, for example by screw machining a tube bar, molding of plastic or powdered metal, cold drawing, cold forming, and other methods. The slits 44 within the cap 4 may be formed by stamping into a steel cap, or by a deep drawing process if the cap 4 were made of powdered metal. The slits 44 may be integrally formed if the cap 4 were made by molding, whether of plastic or metal.

As is common in the prior art, the outer circumference of the piston body 6 has a series of grooves 5, each with a shoulder 17 and a ramp 18 which extend around at least a portion of the outer circumference of the piston body 6. Preferably at least one of the grooves acts a stop groove 7 to help prevent ejection of the piston assembly 8 from the housing 22.

Referring back to FIG. 1, as in prior art tensioners, the housing 22 additionally has a groove 12 for receiving a catch element for engaging the grooves 5 to form a ratchet mechanism. The catch element in FIG. 1 is shown as a circlip 9, but it will be understood that other catch elements can be used, such as pivoting or sliding pawls or octopus clips or similar arrangements as is known in the prior art. The circlip 9 has an expandable ring shaped body 9a. The expandable circlip 9 has a free state in which the ring shaped body 9a engages the plurality of grooves 5 of the piston body 6 and allows limited movement of the piston assembly 8 outwards from the housing 22 and an expanded shape in which the ring shaped body 9a is expanded and disengaged from the plurality of grooves 5 of the piston body 6.

When the expandable ring shaped body 9a of the expandable circlip 9 engages the shoulder 17 of the grooves, extension of the piston assembly 8 outwards from the housing 22 is limited. When the expandable ring shaped body 9a of the expandable circlip 9 engages the ramp 18 of the grooves 5, the expandable circlip 9 allows movement of the piston assembly 8 outwards from the housing 22 and prevents movement of the piston assembly towards the housing 22.

As is common in prior art tensioners, the piston bore 21 of the housing 22 is in fluid communication with a supply through an inlet line 13 and an inlet check valve 14. The inlet check valve 14 allows fluid to flow from the supply into a pressure chamber 20 formed between the interior 6c of the hollow piston body 6 and the piston bore 21 of the housing 22. Also present within the pressure chamber 20 of the tensioner 2 is a spring 15 for biasing the piston assembly 8 outwards from the housing 22.

Fluid present in the pressure chamber 20 may flow out of the tensioner 2 through the slits 44 on the cap 4. The number and depth of the slits 44 determines the hydraulic stiffness of the tensioner 2 as discussed above.

The piston assembly 8 is preferably secured within the housing 22 for shipping and/or installation by a lever 23 and pin 19, although other means may be used.

The pressure relief valve 25 preferably includes a body 28 having a first end 28a and a second end 28b. The first end 28a being open to the pressure chamber 20 and a second end open to a tortuous path disk 30. Present within the body 28 is a spring 26 biasing a ball 27 towards the first end 28a of the body 28.

When the pressure relief valve 25 is closed, the ball 27 blocks the first end 28a of the body 28 of the pressure relief valve 25, and fluid flows from the high pressure chamber 20, and vents through the vent slits 44 of the cap 4.

When the pressure relief valve 25 is open, fluid pressure forces the ball 27 and the spring 26 away from the first end 28a of the body 28 and fluid flows through the body 28 of the pressure relief valve 25, through the tortuous path disk 30, and through bore 43 of the cap 4 and out the vent hole 46 of the cap 4.

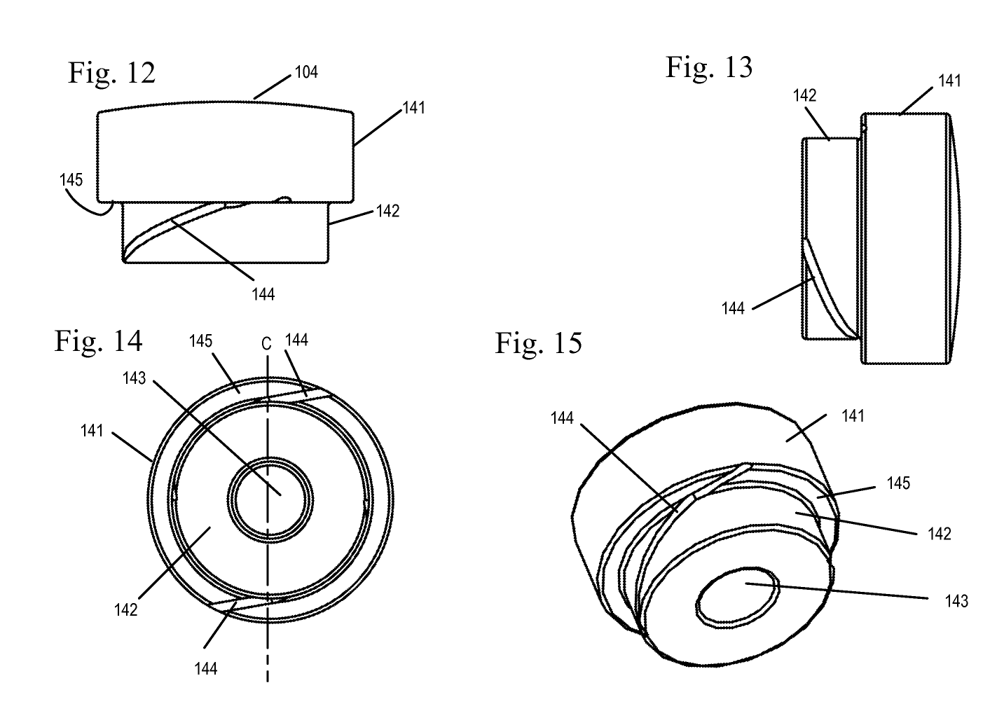

FIGS. 12-15 show an alternate cap design and associated piston assembly 80 that may be used in the tensioner 2 of FIG. 1, replacing piston assembly 8. The piston assembly 80 uses an alternative design for the piston cap 104. The difference between the piston assembly 8 of the first embodiment and the piston assembly 80 of the second embodiment is that the slits 144 on the cap 104 are not vertical relative to the stem 141 of the cap 104, but are angled.

As shown in FIGS. 12-15, the piston cap 104 is mushroom shaped with a head 141 and a stem 142. The stem 142 of the piston cap 104 is received by the first end 6a of the piston body 6, with the underside 145 of the head 141 meeting the first end 6a of the piston body 6. A bore 143, extending from the stem 142 into the top of the head 141 may be present to reduce the weight of the cap. The bore 143 may be other shapes or sizes not shown in the drawings to reduce the weight of the cap 4.

Along at least the stem 142 of the piston cap 104 are angled slits 144 for oil venting. The slits 144 extend from a bottom of the stem 142 to the underside 145 of the head 141 of the cap 104. Fluid can escape or vent from the tensioner, by traveling through the slits 144 on the stem 142 to where the cap 104 meets the piston body 6 and the slits 144 end.

The slits 144 are angled relative to a centerline C of the cap 104. The angle of the slits 144 may vary between slits. The slits 144 may be arranged in a pattern around the outer circumference of the stem. The slits 144 may be of varying depths and widths. The slits 144 may be spiraled grooves or other shapes. The depth and the number of slits 144 may be determined based on the amount of venting required. The venting of the tensioner 2 controls the hydraulic stiffness of the tensioner. The greater the amount of venting of the tensioner 2, the smaller or decreased amount of hydraulic stiffness of the tensioner 2 and the smaller the amount of venting of the tensioner, the greater or increased amount of hydraulic stiffness of the tensioner. The amount of venting necessary may be determined by calculating the total flow as shown in equation (1.1) as discussed above.

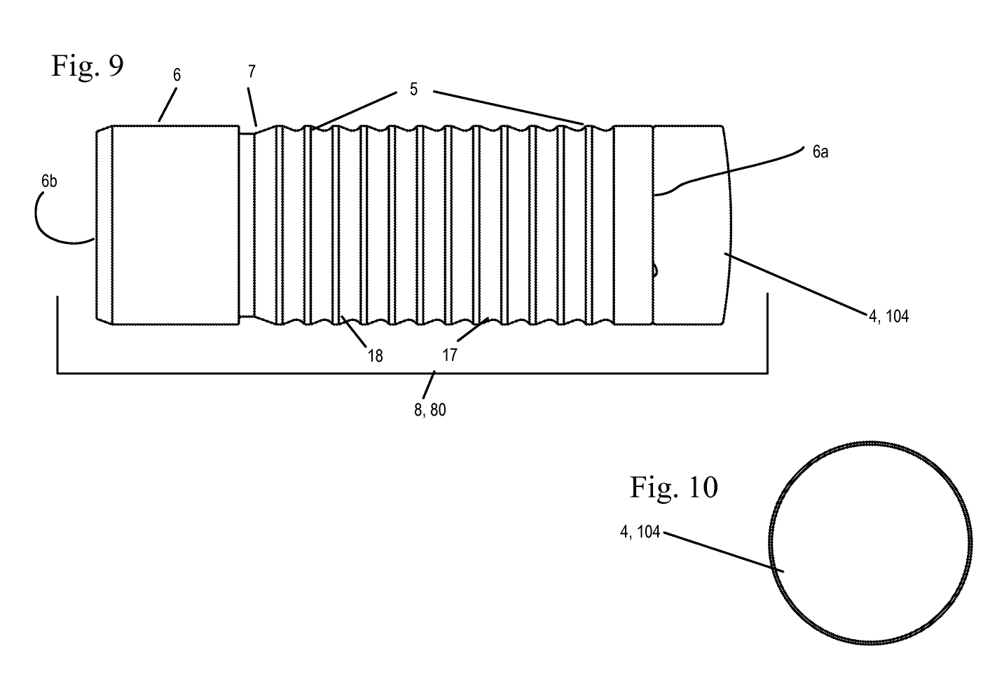

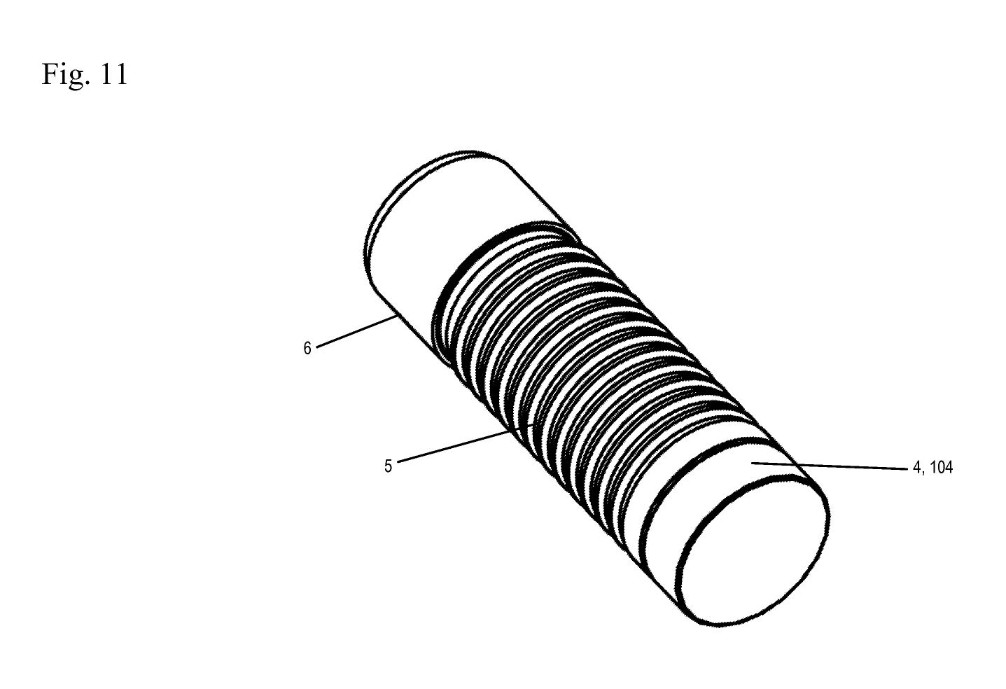

FIGS. 9-11 show the hollow piston body 6 with the piston cap 4, 104 in place. The piston cap 4, 104 is preferably press fit into the first end 6a of the piston body 6, although other methods of securing the piston cap 4 to the piston body 6 may also be used.

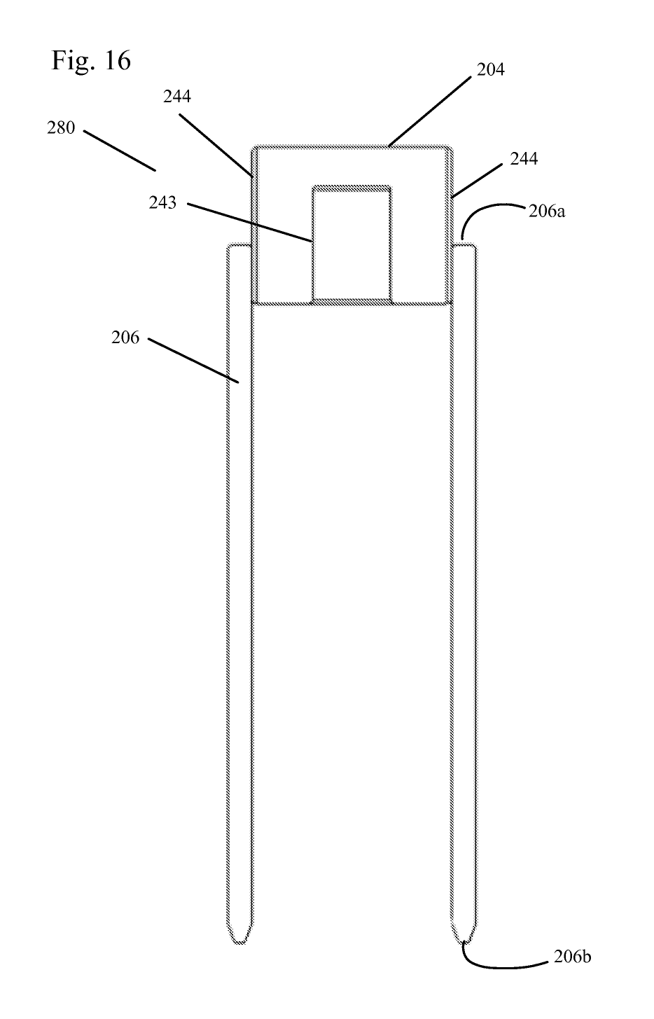

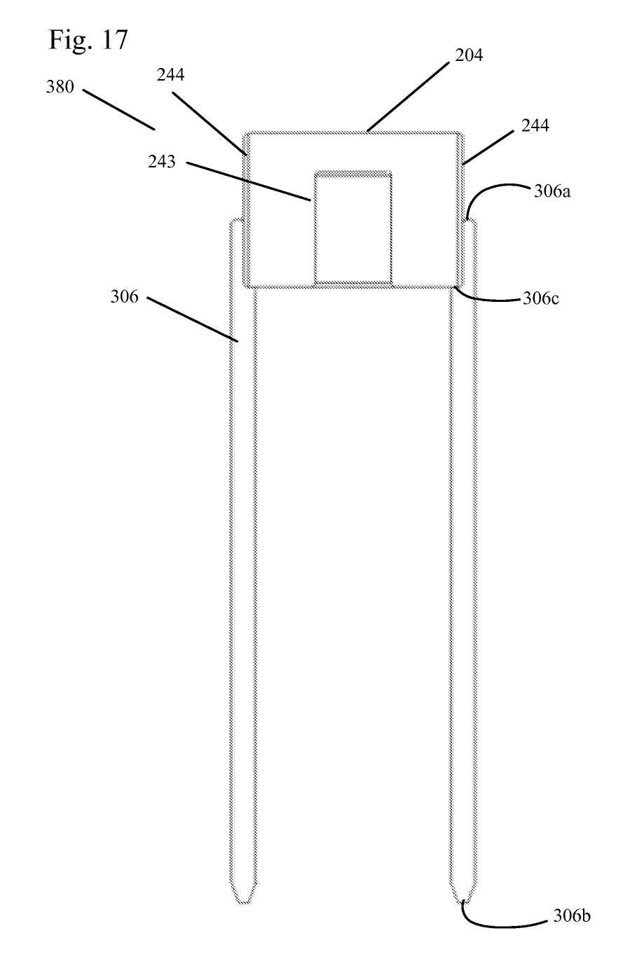

FIGS. 16 and 17 show alternate piston assemblies that can be used with the hydraulic tensioner 2 of FIG. 1. Referring to FIG. 16, the piston assembly 280 includes a hollow piston body 206 and a piston cap 204. The hollow piston body 206 has a first end 206a and a second end 206b. The first end 206a receives the piston cap 204 and the second end 206b is placed within a housing bore 21 of the tensioner 2 of FIG. 1. The piston cap 204 is preferably press fit into the first end 206a of the piston body 206, although other methods of securing the piston cap 204 to the piston body 206 may also be used. While not shown, teeth are preferably present on the outer circumference of the piston body 206. The piston cap 204 has a bore 243 which is preferably used to reduce the weight of the cap 204. The piston cap also has one or more vent slits 244 along an outer circumference.

FIG. 17 shows an alternate piston assembly 380. The piston assembly 380 includes a hollow piston body 306 and a piston cap 204. The hollow piston body 306 has a first end 306a with a shoulder 306c and a second end 306b placed within a housing bore 21 of the tensioner 2 of FIG. 1. The piston cap 204 has a bore 243 which is preferably used to reduce the weight of the cap 204. The piston cap also has one or more vent slits 244 along an outer circumference. The piston cap 204 is preferably press fit into the first end 306a and rests on the shoulder 306c. Other methods of securing the piston cap 204 to the piston body 306 may also be used. While not shown, teeth are preferably present on the outer circumference of the piston body 306.

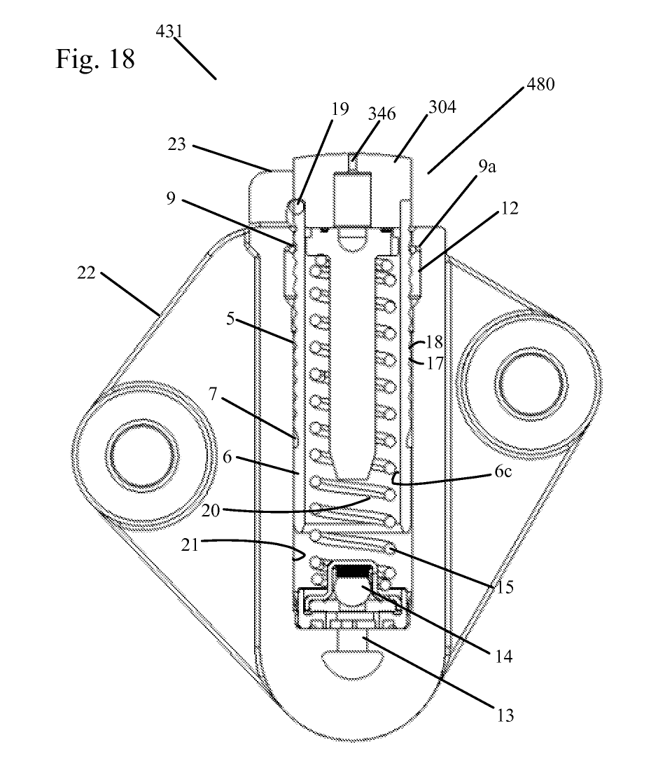

FIG. 18 shows a hydraulic tensioner of a fourth embodiment. The tensioner 431 has a housing 22 with a housing bore 21 for slidably receiving a piston assembly 480. The piston assembly 480 includes a hollow piston body 6 and a piston cap 304.

The hollow piston body 6 has a first end 6a and a second end 6b. The first end 6a receives the piston cap 304 and the second end 6b is placed within the housing bore 21. The piston cap 304 is preferably press fit into the first end 6a of the piston body 6, although other methods of securing the piston cap 304 to the piston body 6 may also be used.

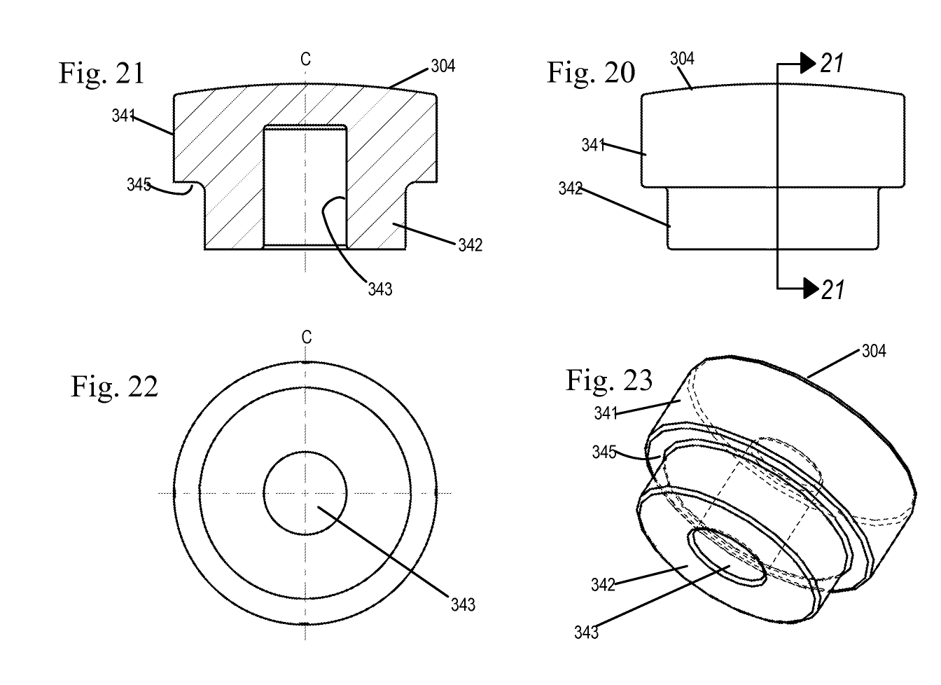

Referring to FIGS. 20-23, the piston cap 304 is mushroom shaped with a head 341 and a stem 342. The stem 342 of the piston cap 304 is received by the first end 6a of the piston body 6, with the underside 345 of the head 341 meeting the first end 6a of the piston body 6. A bore 343, extending from the step 342 into the top of the head 341 may be present to reduce the weight of the cap or to provide a fluid connection through a vent hole 346 if the cap is used with a tensioner that includes a pressure relief valve 25 (see FIG. 20). The bore 343 may be other shapes or sizes not shown in the drawings to reduce the weight of the cap.

As is common in the prior art, the outer circumference of the piston body 6 has a series of grooves 5, each with a shoulder 17 and a ramp 18 which extend around at least a portion of the outer circumference of the piston body 6. Preferably at least one of the grooves acts a stop groove 7 to help prevent ejection of the piston assembly 480 from the housing 22.

Referring back to FIG. 18, as in prior art tensioners, the housing 22 additionally has a groove 12 for receiving a catch element for engaging the grooves 5 to form a ratchet mechanism. The catch element in FIG. 18 is shown as a circlip 9, but it will be understood that other catch elements can be used, such as pivoting or sliding pawls or octopus clips or similar arrangements as is known in the prior art. The circlip 9 has an expandable ring shaped body 9a. The expandable circlip 9 has a free state in which the ring shaped body 9a engages the plurality of grooves 5 of the piston body 6 and allows limited movement of the piston assembly 480 outwards from the housing 22 and an expanded shape in which the ring shaped body 9a is expanded and disengaged from the plurality of grooves 5 of the piston body 6.

When the expandable ring shaped body 9a of the expandable circlip 9 engages the shoulder 17 of the grooves, extension of the piston assembly 480 outwards from the housing 22 is limited. When the expandable ring shaped body 9a of the expandable circlip 9 engages the ramp 18 of the grooves 5, the expandable circlip 9 allows movement of the piston assembly 480 outwards from the housing 22 and prevents movement of the piston assembly towards the housing 22.

As is common in prior art tensioners, the piston bore 21 of the housing 22 is in fluid communication with a supply through an inlet line 13 and an inlet check valve 14. The inlet check valve 14 allows fluid to flow from the supply into a pressure chamber 20 formed between the interior 6c of the hollow piston body 6 and the piston bore 21 of the housing 22. Also present within the pressure chamber 20 of the tensioner 2 is a spring 15 for biasing the piston assembly 480 outwards from the housing 22.

Fluid present in the pressure chamber 20 may flow out of the tensioner 2 through the tortuous path of a vent disk and volume reducer 16.

The piston assembly 480 is preferably secured within the housing 22 for shipping and/or installation by a lever 23 and pin 19, although other means may be used.

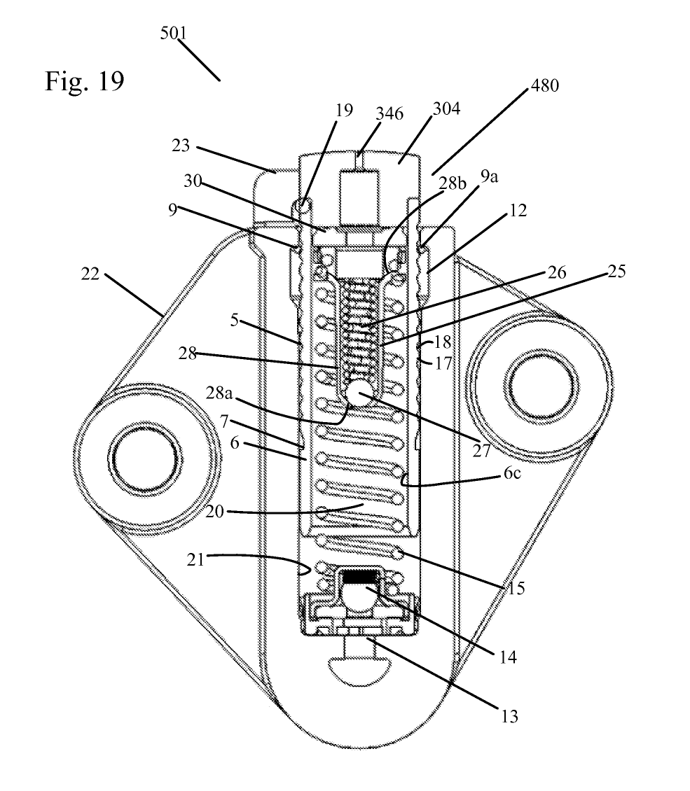

Alternatively, the piston assembly 480 which includes a hollow piston body 6 and a piston cap 304, may be used in a hydraulic tensioner 431 that includes a pressure relief valve 25 and a tortuous path disk 30 as shown in FIG. 19.

The difference between the hydraulic tensioner 431 of FIG. 18 and the hydraulic tensioner 501 of FIG. 19 is the addition of a pressure relief valve 25 and tortuous path disk 30 in the pressure chamber 20 and a vent hole 346 connected to a bore 343 in the cap 304.

The pressure relief valve 25 preferably includes a body 28 having a first end 28a and a second end 28b. The first end 28a being open to the pressure chamber 20 and a second end open to a tortuous path disk 30. Present within the body 28 is a spring 26 biasing an object 27 towards the first end 28a of the body 28.

When the pressure relief valve 25 is closed, the object 27 blocks the first end 28a of the body 28 of the pressure relief valve 25, fluid flows from the high pressure chamber 20, and vents through the volume reducer 16.

When the pressure relief valve 25 is open, fluid pressure forces the object 27 and the spring 26 away from the first end 28a of the body 28 and fluid flows through the body 28 of the pressure relief valve 25, through the tortuous path disk 30, and through bore 343 of the cap 304 and out the vent hole 346 of the cap 304.

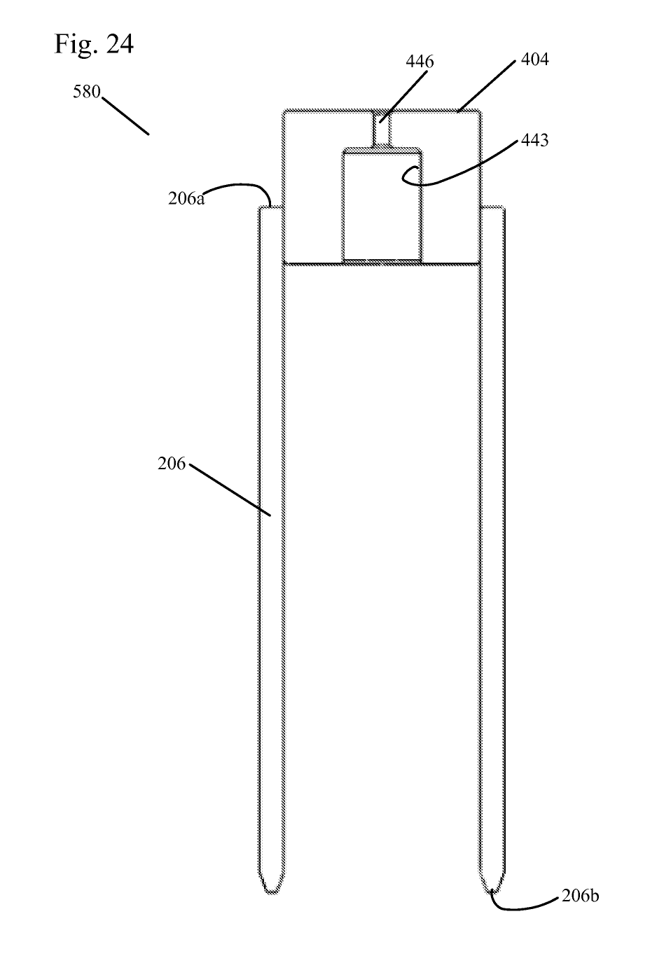

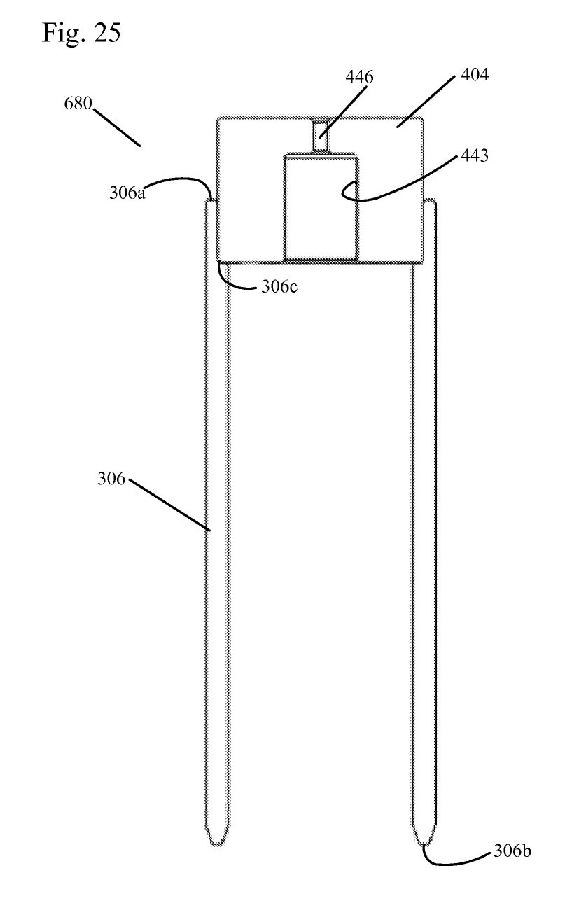

FIGS. 24 and 25 show alternate piston assemblies 580, 680 that can be used with the hydraulic tensioners of FIGS. 18 and 19. Referring to FIG. 24, the piston assembly 580 includes a hollow piston body 206 and a piston cap 404. The hollow piston body 206 has a first end 206a and a second end 206b. The first end 206a receives the piston cap 404 and the second end 206b is placed within a housing bore 21 of the tensioners 431, 501 of FIG. 18 or 20. The piston cap 404 is preferably press fit into the first end 206a of the piston body 206, although other methods of securing the piston cap 404 to the piston body 206 may also be used. While not shown, teeth are preferably present on the outer circumference of the piston body 206.

FIG. 25 shows another alternate piston assembly 680. The piston assembly 680 includes a hollow piston body 306 and a piston cap 404. The hollow piston body 306 having a first end 306a with a shoulder 306c and a second end 306b is placed within a housing bore 32 of the tensioners of FIG. 18 or 19. The piston cap 404 is preferably press fit into the first end 306a and rests on the shoulder 306c. Other methods of securing the piston cap 404 to the piston body 306 may also be used. While not shown, teeth are preferably present on the outer circumference of the piston body 306.

It should be noted that the exact arrangement used to form the ratchet in the tensioner can vary within the teachings of the invention—while the piston bodies 6 of the first and second embodiments are shown with a series of grooves or teeth 5 on the outer circumference, the piston bodies may alternatively have no grooves, or can have a row of teeth on the side of the piston. Also, as discussed above, the catch element which interacts with the grooves or teeth can also vary from the embodiments shown in the figures.

The piston assemblies of the above embodiments may be used in a tensioner system that tensions closed loop chain drives or belt drives for an internal combustion engine.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A piston assembly (8, 80, 280, 380, 480, 580, 680) for a tensioner (2) comprising:
a hollow piston body (6, 206, 306) having a first end (6a, 206a, 306a) and a second end (6b, 206b, 306b); and
a cap (4, 104, 204, 304, 404) comprising: a head (41, 141, 241, 341, 441), the cap received within the first end (6a, 206a, 306a) of the piston body (6, 206, 306).

2. The piston assembly of claim 1, further comprising a pressure relief valve (25) received within the hollow piston body (6, 206, 306) and having an open position and a closed position, wherein when the pressure relief valve (25) is closed, fluid exits the piston body (6, 206, 306) through the cap.

3. The piston assembly of claim 1, wherein the cap (4, 104, 204) further comprises at least one slit (44, 144, 244) for venting fluid, having a width and a depth.

4. The piston assembly of claim 3, wherein the slit (44, 144, 244) is parallel to a centerline (C) of the cap (4, 104, 204).

5. The piston assembly of claim 3, wherein the slit (144) is angled relative to a centerline (C) of the cap (104).

6. The piston assembly of claim 1, wherein the cap (4, 104) has a plurality of slits (44, 144).

7. (canceled)

8. (canceled)

9. (canceled)

10. The piston assembly of claim 1, wherein the cap (4, 104, 204, 304, 404) and the piston body (6, 206, 306) are made of different materials.

11. The piston assembly of claim 1, wherein the cap (4, 104, 304) further comprises a stem (42, 142, 342) connected to an underside (45, 145, 345) of the head (41, 141, 341) and fitting within the first end (6a) of the piston body (6).

12. The piston assembly of claim 11, wherein the stem (42, 142, 342) of the cap (4, 104, 304) is press fit into the first end (6a) of the piston body (6).

13. The piston assembly of claim 11, further comprising a bore (43, 143, 343) within the cap (4, 104, 304) extending from the stem (42, 142, 342) into the head of the cap (4, 104, 304).

14. The piston assembly of claim 11, wherein a slit extends from an outer circumference of the stem (42, 142) and across the underside (45, 145) of the head (41, 141).

15. The piston assembly of claim 1, wherein the piston body (6, 206, 306) has a series of grooves (5) along at least a portion of an outer circumference.

16. The piston assembly of claim 1, wherein the hollow piston body (306) has a shoulder (306c) for receiving the cap (204, 404) at a first end (306a).

17. A tensioner (2) for tensioning a belt or a chain comprising:
a housing (22) having a bore (21) connected to a supply through an inlet line (13);
a piston assembly (8, 80) slidably received within the bore (21) of the housing (22), the piston assembly (8, 80) comprising:
a hollow piston body (6) having a first end (6a) and a second end (6b); and
a cap (4, 104) having:
a head (41, 141);
a stem (42, 142) connected to an underside (45, 145) of the head (41, 141) and fitting within the first end (6a) of the piston body (6); and
at least one slit (44, 144) having a width and a depth, extending from an outer circumference of the stem (42, 142) and across the underside (45, 145) of the head (41, 141);
a pressure chamber (20) formed between the second end (6b) of the piston body (6) and the bore (21) of the housing (22); and
wherein fluid present in the pressure chamber (20) is vented from the pressure chamber (20) by traveling through the at least one slit (44, 144) to the underside (45, 145) of the head (41, 141) of the cap (4, 104).

18. A tensioner (2) for tensioning a belt or a chain comprising:
a housing (22) having a bore (21) connected to a supply through an inlet line (13);
a piston assembly (8, 80, 280, 380, 480, 580, 680) slidably received within the bore (21) of the housing (22), the piston assembly (8, 80) comprising:
a hollow piston body (6, 206, 306) having a first end (6a, 206a, 306a) and a second end (6b, 206b, 306b); and
a cap (4, 104, 204, 304, 404) comprising: a head (41, 141, 241, 341, 441), the cap received within the first end (6a, 206a, 306a) of the piston body (6, 206, 306a hollow piston body (6) having a first end (6a) and a second end (6b); and
a pressure relief valve (25) received within the hollow piston body (6, 206, 306) and having an open position and a closed position;
a pressure chamber (20) formed between the second end (6b) of the piston body (6) and the bore (21) of the housing (22); and
wherein fluid present in the pressure chamber (20) is vented from the pressure chamber (20) by traveling through the pressure relief valve (25) in the open position or through the cap (4, 104) when the pressure relief valve (25) is in the closed position.

19. The tensioner of claim 17, wherein the piston body (6) has a series of grooves (5) along at least a portion of an outer circumference.

20. The tensioner of claim 17, further comprising a catch element (9) in the housing (22), interacting with the grooves (5) on the piston body (6) to form a ratchet.

21. The tensioner of claim 17, wherein the cap (4, 104) and the piston body (6) are made of different materials.

22. The tensioner of claim 18, wherein the piston body (6) has a series of grooves (5) along at least a portion of an outer circumference.

23. The tensioner of claim 18, further comprising a catch element (9) in the housing (22), interacting with the grooves (5) on the piston body (6) to form a ratchet.

24. The tensioner of claim 18, wherein the cap (4, 104) and the piston body (6) are made of different materials.
